(19) United States
(12) Patent Application Publication
(10) Pub. No.: US 2024/0273225 A1
(43) Pub. Date: Aug. 15, 2024

(54) Methods and Systems for Generating, Maintaining, and Using Information Related to Vehicle Seats Stored on a Blockchain

(71) Applicant: STATE FARM MUTUAL AUTOMOBILE INSURANCE COMPANY, Bloomington, IL (US)

(72) Inventors: Catherine Espel-Logan, Plano, TX (US); Brian Mark Fields, Phoenix, AZ (US); Joshua John Freitas, Peoria, AZ (US); Melissa Collette Miles, Normal, IL (US); Jeanne Koehler, Bloomington, IL (US)

(21) Appl. No.: 18/416,853

(22) Filed: Jan. 18, 2024

Related U.S. Application Data
(60) Provisional application No. 63/541,659, filed on Sep. 29, 2023.
(60) Provisional application No. 63/530,418, filed on Aug. 2, 2023.
(60) Provisional application No. 63/524,035, filed on Jun. 29, 2023.
(60) Provisional application No. 63/488,042, filed on Mar. 2, 2023.
(60) Provisional application No. 63/445,879, filed on Feb. 15, 2023.

(51) Int. Cl. G06F 21/62; G06Q 50/18; H04L 9/00; H04L 9/30

(52) U.S. Cl. CPC G06F 21/6218; G06Q 50/184; H04L 9/3073; H04L 9/50

(57) ABSTRACT

Methods and systems for maintaining and classifying data related to vehicle seats stored on a blockchain. The systems and methods may include (1) detecting one or more sets of data relating to vehicle seats; (2) executing a data maintenance smart contact to classify the sets of data as being publicly accessible or proprietary; (3) based upon the classification assigned by the data maintenance smart contract, adding the one or more sets of data to a data repository accessible via a blockchain; (4) detecting a request to access a requested set of proprietary data from a requestor; (5) executing a security smart contract to determine whether the requestor is authorized to access the requested set of proprietary data; and/or (6) enforcing the determination of the security smart contract with respect to the request.

### CROSS REFERENCE TO RELATED APPLICATIONS

The present application claims the benefit of U.S. Provisional Patent Application No. 63/541,659, entitled “Methods and Systems of Using Augmented Reality for Visualizing the Proper Fastening of a Vehicle Seat,” filed on Sep. 29, 2023, U.S. Provisional Patent Application No. 63/530,418, entitled “Methods and Systems for Generating, Maintaining, and Using Information Related to Vehicle Seats Stored on a Blockchain,” filed on Aug. 2, 2023, U.S. Provisional Patent Application No. 63/524,035, entitled “Methods and Systems of Using Augmented Reality for Visualizing the Proper Fastening of a Vehicle Seat,” filed on Jun. 29, 2023, U.S. Provisional Patent Application No. 63/488,042, entitled “Methods and Systems for Automated Vehicle Seat Replacement,” filed on Mar. 2, 2023, U.S. Provisional Patent Application No. 63/445,879, entitled “Methods and Systems for Simulating a Vehicle Seat in a Vehicle,” filed on Feb. 15, 2023, each of which are hereby expressly incorporated by reference herein in their entirety.

### TECHNICAL FIELD

The present disclosure generally relates to generating smart contracts for a distributed ledger that governs transactions or events, and more particularly, maintaining and classifying data related to vehicle seats stored on a blockchain.

### BACKGROUND

Finding information about vehicle seats continues to be a challenge. One problem may be the disorganization and scattering of relevant information across various sources. Currently, there may not be any comprehensive databases or easily accessible platforms where one can find all the pertinent information about various vehicle seats (e.g., difference between models, safety guidelines, installation procedures, etc.). As a result, queries must be made across various websites, which may often cause several sources of relevant information to be overlooked.

Another problem may the credibility and trustworthiness of the information publicly available online. With the abundance of websites and forums on the topic, it may become difficult to discern which sources are backed by credible experts and which are mere opinions or marketing tactics. Additionally, misleading or outdated information or neglectful omissions (such as the crucial dimensions of a vehicle seat) may cause potential purchasers to make ill-informed decisions, thereby endangering passengers. Further, not all pertinent information for purchasers may be publicly accessible.

As such, there remains a pressing need for a comprehensive platform of information related to vehicle seats. Conventional techniques may include additional drawbacks, ineffectiveness, inefficiencies, and encumbrances as well.

### SUMMARY

In some embodiments, a computer-implemented method for generating one or more smart contracts for deployment onto a blockchain may be provided. The method may be implemented via one or more local or remote processors, transceivers, sensors, servers, memory units, mobile devices, wearables, smart devices, smart glasses, augmented reality (AR) glasses, virtual reality (VR) headsets, extended or mixed reality glasses or headsets, voice bots, chat bots, ChatGPT bots, ChatGPT-based bots, and/or other electronic or electrical components, which may be in wired or wireless communication with one another. For example, in one instance, the method may include: (1) detecting, by one or more processors, one or more sets of data relating to vehicle seats; (2) executing, by the one or more processors, a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, adding, by the one or more processors, the one or more sets of data to a data repository accessible via a blockchain, wherein the one or more sets of data classified as proprietary may be encrypted upon being added to the data repository; (4) detecting, by the one or more processors from a requestor, a request to access a requested set of proprietary data; (5) executing, by the one or more processors, a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforcing, by the one or more processors, the determination of the security smart contract with respect to the request. The method may include additional, less, or alternate actions, including those discussed elsewhere herein.

In other embodiments, a computer system for generating one or more smart contracts for deployment onto a blockchain may be provided. The computer system may include, or be configured to work with, one or more local or remote processors, transceivers, sensors, servers, memory units, mobile devices, wearables, smart devices, smart glasses, augmented reality (AR) glasses, virtual reality (VR) headsets, extended or mixed reality glasses or headsets, voice bots, chat bots, ChatGPT bots, ChatGPT-based bots, and/or other electronic or electrical components, which may be in wired or wireless communication with one another. For example, in one instance, the computing system may include one or more processors and associated transceivers, and a non-transitory program memory coupled to the one or more processors and storing executable instructions that, when executed by the one or more processors, cause the computer system to: (1) detect one or more sets of data relating to vehicle seats; (2) execute a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, add the one or more sets of data to a data repository accessible via a blockchain, wherein the one or more sets of data classified as proprietary may be encrypted upon being added to the data repository; (4) detect a request to access a requested set of proprietary data from a requestor; (5) execute a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforce the determination of the security smart contract with respect to the request. The computer system may be configured to include additional, less, or alternate functionality, including that discussed elsewhere herein.

In yet other embodiments, a tangible, a non-transitory computer-readable medium for generating one or more smart contracts for deployment onto a blockchain may be provided. The executable instructions, when executed by one or more processors of a computer system, cause the computer system to: (1) detect one or more sets of data relating to vehicle seats; (2) execute a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, add the one or more sets of data to a data repository accessible via a blockchain, wherein the one or more sets of data classified as proprietary may be encrypted upon being added to the data repository; (4) detect a request to access a requested set of proprietary data from a requestor; (5) execute a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforce the determination of the security smart contract with respect to the request. The instructions may direct additional, less, or alternate functionality, including that discussed elsewhere herein.

Advantages will become more apparent to those of ordinary skill in the art from the following description of the preferred embodiments, which have been shown and described by way of illustration. As will be realized, the present embodiments may be capable of other and different embodiments, and details are capable of modification in various respects. Accordingly, the drawings and description are to be regarded as illustrative in nature and not as restrictive.

### BRIEF DESCRIPTION OF THE DRAWINGS

The figures described below depict various embodiments of the systems and methods disclosed herein. It should be understood that the figures depict illustrative embodiments of the disclosed systems and methods, and that the figures are intended to be exemplary in nature. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1A depicts an exemplary computing environment for implementing the methods and systems for maintaining and classifying data related to vehicle seats stored on a blockchain;

FIG. 1B depicts an exemplary node for the implementing the methods and systems for maintaining and classifying data related to vehicle seats stored on a blockchain;

FIG. 2A depicts an exemplary data maintenance smart contract for maintaining and classifying data related to vehicle seats stored on a blockchain;

FIG. 2B depicts an exemplary security smart contract for authorizing nodes requesting access to data related to vehicle seats stored on a blockchain;

FIG. 3 depicts example signal diagrams for the implementation for the computer-implemented methods and systems for maintaining and classifying data related to vehicle seats stored on a blockchain; and

FIG. 4 depicts an exemplary computer-implemented method for maintaining and classifying data related to vehicle seats stored on a blockchain.

The figures depict the present embodiments for purposes of illustration only. One skilled in the art will readily recognize from the following discussion that alternate embodiments of the structures and methods illustrated herein may be employed without departing from the principles of the invention described herein.

### DETAILED DESCRIPTION

To assist owners and manufacturers of replacement vehicle seats, systems and methods for maintaining and/or classifying data related to vehicle seats stored on a blockchain are described herein.

One or more nodes of a blockchain may submit data related to vehicle seats to be stored at a data repository accessible via the blockchain. The data repository may include data that is either “publicly accessible” or “proprietary.”

Publicly accessible data may be accessed by any node on the blockchain. In some embodiments, the publicly accessible data is automatically gathered via data scrapping of one or more publicly accessible websites by one or more nodes on the blockchain. When a node requests that data is stored in the data repository of the blockchain, one or more data processing nodes may (i) determine whether the data submitted is related to vehicle seats and/or (ii) classify the data as publicly accessible or proprietary. In some embodiments, the data processing nodes may determine that the data is related to vehicle seats via data analysis of the data submitted (e.g., keyword searching). Additionally or alternatively, in some embodiments, the data processing nodes may classify the submitted data as publicly accessible (i) by one or more indications included with the data submission that the data is publicly accessible (ii) if one or more nodes are able of locate the submitted data on a publicly accessible website and/or (iii) by analyzing one or more characteristics of the node that submitted the data.

Proprietary information may be accessed by only some of the one or more entities of the blockchain (e.g., insurance entities, vehicle seat OEMs, vehicle OEMs, etc.). The proprietary information may include data not accessible by the public, but still valuable to vehicle seat consumers and/or other entities in the automotive industry. To restrict access to the proprietary information, the proprietary information may be encrypted. As such, nodes may not access the proprietary information unless they are authenticated (e.g., via a security credential, identification data, etc.) and have the corresponding decryption key to view the proprietary information. In some embodiments, the proprietary information may be restricted by a tiered subscription system, where additional portions of the proprietary information become accessible to a node at different tiers.

In this way, any and all data related to vehicle seats may be found in one data repository and easily accessible to consumers and automotive entities alike.

### Exemplary Blockchains

The present embodiments may involve, inter alia, the use of a blockchain. A blockchain (also referred to herein as a distributed ledger or a shared ledger) is a way of achieving a distributed consensus on the validity or invalidity of information in the chain. In other words, the blockchain provides a decentralized trust to participants and observers. As opposed to relying on a central authority, a blockchain is a decentralized database in which a transactional record of changes to the ledger is maintained and validated by each node of a peer-to-peer (P2P) network. The blockchain may be comprised of groupings of transactions organized together into a “block,” and ordered sequentially (thus the term “blockchain”). Nodes may join and leave the blockchain network over time and may obtain blocks that were propagated while the node was gone from peer nodes. Nodes may maintain addresses of other nodes, and exchange addresses of known nodes with one another to facilitate the propagation of new information across the network in a decentralized, P2P manner.

In one application of the blockchain, each new block may be cryptographically linked to the previous block in order to form the blockchain. More particularly, to create a new block, each transaction within a block may be assigned a hash value (i.e., an output of a cryptographic hash function, such as SHA-2 or MD5). These hash values may then be combined together utilizing cryptographic techniques (e.g., a Merkle Tree) to generate a hash value representative of the entire new block. This hash value may then be combined with the hash value of the previous block to form a hash value included in the header of the new block, thereby cryptographically linking the new block to the blockchain. To this end, the precise value utilized in the header of the new block may be dependent on the hash value for each transaction in the new block, as well as the hash value for each transaction in every prior block.

According to some embodiments, the hash value generated for the new block may be used as an input to a cryptographic puzzle that manipulates a nonce value. When a solution to the cryptographic puzzle is found, the solving node publishes the solution and the other nodes then verify that the solution is the correct solution. Because the solution may also depend on the particular hash values for each transaction within the blockchain, if the solving node attempted to modify any transaction, the solution would not be verified by the other nodes.

More particularly, if a single node attempts to modify a prior transaction within the blockchain, a cascade of different hash values may be generated for each tier of the cryptographic combination technique. This may result in the header for one or more blocks being different than the corresponding header(s) in every other node that did not make the exact same modification. As a result, the solution generated by the modifying node would not solve the cryptographic puzzle presented to any node without the identical modification. Thus, the version of the new block generated by the modifying node may be readily recognized as including an improper modification and rejected by the consensus. This inability to modify past transactions lead to blockchains being generally described as trusted, secure, and/or immutable.

The nodes that share the blockchain form what is referred to herein as the blockchain network. The nodes may each store a respective copy of the blockchain and/or validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supplies a proof-of-identity such that only approved entities may originate changes to the chain. A consensus rule may require that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules may be propagated from nodes that have validated the addition to other nodes that the validating node is aware of. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule may be disregarded by validating nodes that receive the change and is not propagated to other nodes. Accordingly, unlike a traditional system which uses a central authority, a single party cannot unilaterally alter the distributed ledger unless the single party does so in a way that satisfies the consensus rules.

The validation activities of nodes applying consensus rules on a blockchain network may take various forms. In some embodiments, the validating nodes execute code contained in “smart contracts” and distributed consensus may be expressed as the network nodes agreeing on the output of the executed code.

Blockchains may be deployed in a public, decentralized, and permissionless manner meaning that any party may view the blockchain, submit new information to be added to the blockchain, or join the network as a validating node. Other blockchains may be private (e.g., permissioned ledgers) that keep chain data private among a group of entities authorized to participate in the blockchain network. The blockchain may be either a public or private ledger.

### Exemplary Digital Signatures

As noted above, the blockchain may be private or public, and data on the blockchain may be encrypted to protect data privacy. Similarly, nodes accessing the blockchain may have a form of identification that may be checked by the blockchain (e.g., by smart contracts written thereon) to ensure the nodes have access to perform a requested action associated with the blockchain and/or the data associated therewith.

One way to verify the nodes have valid access is through the implementation of a digital signature or signed credential. For example, a node may want to access the blockchain for the first time to transfer data to or retrieve data from a data repository associated with the blockchain. Accordingly, the node may generate a public/private key pair to utilize for interactions with the blockchain. When attempting to access the blockchain, a smart contract on the blockchain may request the public key from the node for storage in a public key repository associated with the blockchain.

In some embodiments, the smart contract may also generate a unique code assigned to node or signed credential to the node. The signed credential may be any form of a self-executing verification credential, including the DID as described in U.S. Provisional Patent Application No. 63/400,717 (which was incorporated by reference in its entirety above). The unique code and/or signed credential may be stored in a web browser, or mobile application executed by the node. When the node attempts to access the blockchain, the node may include a digital signature that encrypts the unique code using the private key of the node's key pair. As a result, a smart contract executing thereon may validate a request by obtaining the node's public key from the public key repository and ensuring that the decrypted digital signature resolves to the unique code and/or credential. Thus, the validation may be based upon both information that is self-sovereign (i.e., the public key) as well as information that smart contracts on the blockchain may use to verify that the node has validated access to the blockchain (i.e., the authentication data).

More particularly, in the signed credential examples, the smart contract may process the access request and determine that the request is valid, due to the presence of the authentication data and/or the public key in a known file format (e.g., a binary distinguished encoding rules (DER) format, XML format, base64 format, etc.) included with the access request. In response to determining that a valid access request has been received, the smart contract may generate the signed credential and provide the signed credential to the node. As such, when the node attempts to interact with the blockchain, the node may include in the interaction request the signed credential for verification by a smart contract.

### Exemplary Computing Environment

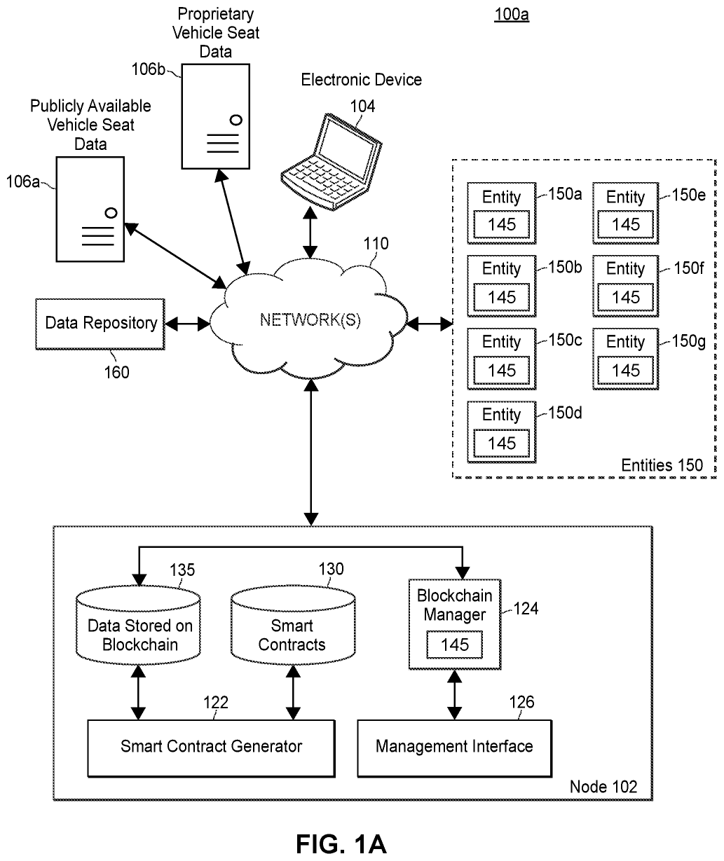

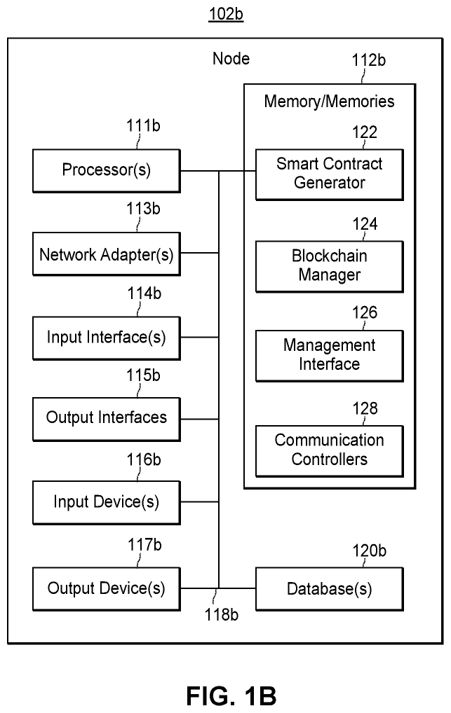

FIG. 1A depicts a diagram of an exemplary computing environment 100a. The exemplary computing environment 100a may include a node 102, an electronic device 104, one or more databases of publicly available vehicle seat data 106a, one or more databases of proprietary vehicle seat data 106b, one or more networks 110, one or more entities 150, and/or a data repository 160. Although FIG. 1A depicts certain entities, components, and devices, it should be appreciated that additional or alternate entities and components are envisioned.

The node 102 may include a smart contract generator 122, a blockchain manager 124, and/or a management interface 126. The smart contract generator 122 may generate one or more smart contracts 130. The blockchain manager 124 may manage access to and/or interactions with a blockchain 145. The node 102 may include a portion of a memory unit configured to store software and/or computer-executable instructions that, when executed by a processing unit, may cause the one or more of the above-described components to maintain and/or classify data related to vehicle seats stored on a blockchain. In some embodiments, the node 102 may be a server computing device, a personal electronic device (e.g., the electronic device 104), and/or other types of computing devices. In embodiments where the node 102 is a server, the node 102 may include one or more interconnected servers, for example, in a cloud computing environment. While FIG. 1A depicts the node 102 being a separate entity as the electronic device 104, in some embodiments, the electronic device 104 may be configured to also operate as the node 102.

The electronic device 104 may be a computing device such as a laptop computer, a tablet, a smartphone or other smart device, a desktop device, a wearable device, mobile device, smart contacts, smart glasses, augmented reality (AR) glasses, virtual reality (VR) headset, extended or mixed reality (MR) glasses or headsets, voice bots, chat bots, ChatGPT bots, ChatGPT-based bots, etc.

The one or more databases of publicly available vehicle seat data 106a and/or the one or more databases of proprietary vehicle seat data 106b may include one or more databases, one or more servers, one or more data repositories, etc. The example computing environment 100 may include additional databases not shown in FIG. 1A.

The one or more networks 110 may be, or may include, the internet, a local area network (LAN), a metropolitan area network (MAN), a wide area network (WAN), a wired network, a Wi-Fi network, a cellular network, a wireless network, a private network, a virtual private network, etc. The one or more networks 110 may facilitate any data communication between/among the node 102, the electronic device 104, the one or more entities 150, the one or more databases (e.g., the one or more databases of publicly available vehicle seat data 106a and/or the one or more databases of proprietary vehicle seat data 106b) and/or the data repository 160 via any standard or technology (e.g., GSM, CDMA, TDMA, WCDMA, LTE, 5G, 6G, EDGE, OFDM, GPRS, EV-DO, UWB, IEEE 802 including Ethernet, WiMAX, and/or others). According to some embodiments, the node 102, the electronic device 104, and/or the one or more entities 150 may transmit generated transactions to the blockchain 145 via the one or more networks 110.

The one or more entities 150 may be one or more nodes 102 of the blockchain 145. The one or more entities 150 may include an insurance entity 150a, a vehicle seat OEM entity 150b, a vehicle OEM entity 150c, a government entity 150d, an academic entity 150e, a commercial entity 150f, a social media entity 150g, and/or the electronic device 104. Additionally and/or alternatively, the one or more entities may receive updates to the blockchain 145 and/or deploy smart contracts to the blockchain 145.

The blockchain 145 may be any type of blockchain or decentralized ledger. The blockchain 145 may include one or more smart contracts that, when executed by one or more nodes 102, may maintain, classify, and/or restrict access to data stored in the data repository 160.

The data repository 160 may include one or more databases and/or data repositories that store data related to vehicle seats. In some embodiments, the data repository 160 is maintained at least in part on the blockchain 145. For example, the data repository 160 may include an on-chain index of off-chain locations at which the data maintained in the blockchain is located. The node 102 may execute a data analysis application (not pictured) programmed to analyze data that is maintained and/or requested to be maintained at the data repository 160. In some embodiments, the data analysis application may be configured to generate one or more blockchain transactions requesting access to the data that is to be analyzed.

In operation, the node 102, the electronic device 104, and/or the one or more entities 150 may establish a communicative connection with the blockchain 145 (e.g., one or more nodes on the blockchain and/or the data repository 160) via the one or more networks 110. In some embodiments, establishing the connection may include the node 102, the electronic device 104, and/or the one or more entities 150 signing into an account verifiable via one or more smart contracts stored on the blockchain. Additionally or alternatively, the node 102, the electronic device 104, and/or the one or more entities 150 may establish the connection via an application. In some embodiments, the connection may be through either a third party connection or a direct peer-to-peer (P2P) connection/transmission.

According to certain aspects, the node 102 may execute the data analysis application to detect data relating to vehicle seats. In these embodiments, the node 102 may detect data provided by the electronic device(s) 104, the entity/entities 150 via a direct communication connection. In other embodiments, the data is included in a transaction written to the blockchain 145. In still other embodiments, the data may be stored at an off-chain location referenced by the transaction. The node 102 may then execute a smart contract to (e.g., a data maintenance smart contact) to analyze the data to determine aspects about the data (e.g., whether the data includes data related to vehicle seats) pertinent to its import into the data repository 160.

As an example, the data analysis application may execute a smart contract (e.g., a data maintenance smart contact) to analyze transactions of the blockchain 145 to detect a triggering event of a request for data to be uploaded to the data repository 160. In this example, in response to detecting the triggering event, the data analysis application may then analyze data included with the transaction to determine (i) whether the detected data relates to vehicle seats and/or (ii) whether the detected data is publicly accessible or proprietary. As another example, the data analysis application may execute a smart contract (e.g., a security smart contact) to analyze transactions of the blockchain 145 to detect a triggering event of a request to access one or more sets of data stored in the data repository 160. In this example, in response to detecting the triggering event, the data analysis application may then analyze data included with the transaction to determine whether the requestor is authorized to access the requested data.

In some embodiments, after executing adding data to the data repository 160, the node 102 may execute the smart contract generator 122 to generate a security smart contract for controlling access to the data. The node 102 may then deploy the generated smart contract onto the blockchain 145. For example, the node 102 may store the smart contracts at a particular storage location associated with smart contracts of the blockchain 145. Accordingly, nodes 102 that enforce smart contracts of the blockchain 145 are able to locate the newly generated smart contract for enforcement thereof.

According to some embodiments, a requesting node requesting access to the data maintained at the data repository 160 may include authentication information as part of a transaction written to the blockchain 145. The authentication information may include identification data (e.g., a PIN number, a serial number or some other identifier of the node 102 attempting access, a username or number of an account associated with the node 102 attempting access, etc.) and/or a security credential (e.g., a private key associated with one or more sets of requested data stored on the data repository 160, a DID, etc.).

To enforce the smart contracts, the node 102 may be configured to identify transactions pertinent to the one or more smart contract of the blockchain 145 and/or route data extracted from the transaction to the pertinent smart contracts. For example, the node 102 may utilize the identity data to identify only those smart contracts deployed on the blockchain 145 that are relevant to the requested sets of data stored on the data repository 160. In turn, the identified one or more smart contracts may self-execute on the node 102 to determine whether a triggering event has occurred.

When the particular smart contract indicates that a triggering event has occurred, the particular smart contract may direct the node 102 to perform an action. For example, the actions defined by a data maintenance smart contract may be to analyze data associated with the transaction that satisfied the triggering event to (i) label data as not related to vehicle seats if the data contains no discernable association to vehicle seats, (ii) label submitted data as related to vehicle seats if the data contains at least one discernable association to vehicle seats, (iii) classify data labelled as related to vehicle seats as “publicly accessible” if the data the data is permitted to be publicly accessed, and/or (iv) classify data labelled as related to vehicle seats as “proprietary” if the data is not permitted to be publicly accessed. As another example, the action defined by a security smart contract may be to analyze data associated with a request to access data to determine (i) whether requested data requested is proprietary and (ii) in the event the requested data being proprietary, whether the requestor is authorized to access the requested data. For example, the node 102 may analyze data included with the request (e.g., a digital signature, identification data, etc.) to determine whether the requestor has authorization to access the requested proprietary data.

As illustrated, the node 102 may include a blockchain manager 124. The blockchain manager 124 may be a software program, engine, and/or a module that is executed by one or more processors interconnected within the node 102 and configured to (i) compile one or more transactions into a block; (ii) update the blockchain 145 to include a new block; (iii) route the transactions to applicable smart contracts; and/or (iv) automatically execute and/or enforce smart contracts of the blockchain 145.

According to some embodiments, an administrator of the node 102 may interact with a management interface 126 to interface with the blockchain 145 and/or set control parameters associated with the blockchain manager 124.

It should be appreciated that although the node 102 and one or more entities 150 are shown as separate entities, in some embodiments, any one or more of the one or more entities 150 may be, or otherwise include functionality of, the node 102. For example, any of the entities 150 may also include a smart contract generator 122, a blockchain manager 124, and/or a management interface 126.

Although FIG. 1A illustrates the node 102 as a single entity having the described components, it should be appreciated that the node 102 may include additional, fewer, or alternate components. The exemplary computing system 100 may include additional, fewer, or alternate equipment or components, including those discussed elsewhere herein.

### Exemplary Node

FIG. 1B depicts an exemplary node 102b of the blockchain 145. The exemplary node 102b may include one or more processors 111b, one or more memories 112b, one or more network adapters 113b, one or more input interfaces 114b, one or more output interfaces 115b, one or more input devices 116b, one or more output devices 117b, and/or one or more databases 120b. Any of the components of the exemplary node 102b may be communicatively coupled to one another via a communication bus 118b.

The one or more processors 111b may include one or more central processing units (CPU), one or more coprocessors, one or more microprocessors, one or more graphical processing units (GPU), one or more digital signal processors (DSP), one or more application specific integrated circuits (ASIC), one or more programmable logic devices (PLD), one or more field-programmable gate arrays (FPGA), one or more field-programmable logic devices (FPLD), one or more microcontroller units (MCUs), one or more hardware accelerators, one or more special-purpose computer chips, and one or more system-on-a-chip (SoC) devices, etc.

The one or more memories 112b may include any local short term memory (e.g., random access memory (RAM), read only memory (ROM), cache, etc.) and/or any long term memory (e.g., hard disk drives (HDD), solid state drives (SSD), etc.). The memories 112b may store computer-readable instructions configured to implement the methods described herein. For example, the one or more memories 112b may store the smart contract generator 122, the blockchain manager 124, and/or the management interface 126 of FIG. 1A. Additionally, in some embodiments, the one or more memories 112b may also store one or more communication controllers 128. The one or more communication controllers 128 may be executable instructions to send and/or receive electronic data via the one or more network adapters 113b.

The one or more network adapters 113b may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over a communication network (e.g., the one or more networks 110).

The one or more input interfaces 114b may include any number of different types of input units, input circuits, and/or input components via which the one or more processors 111b to communicate with the one or more input devices 116b (such as keyboards and/or keypads, interactive screens (e.g., touch screens), navigation devices (e.g., a mouse, a trackball, a capacitive touch pad, a joystick, etc.), microphones, buttons, communication interfaces, etc.). Similarly, the one or more output interfaces 115b may be include any number of different types of input units, input circuits, and/or input components via which the one or more processors 111b to communicate the one or more output devices 117b (display units (e.g., display screens, receipt printers, etc.), speakers, etc.). In some embodiments, the one or more input interfaces 114b and the one or more output interfaces 115b may be combined into input/output (I/O) units, I/O circuits, and/or I/O components.

The one or more databases 120b may include one or more databases, data repositories (e.g., the data stored on the blockchain 145 and/or the smart contracts 130 of FIG. 1A), etc.

The communications bus 118b may include any dedicated or general-purpose communication bus implementing a bus access protocol that facilitates the communications between the various components of the exemplary node 102b.

### Exemplary Smart Contracts

According to certain aspects, the present embodiments may relate to, inter alia, creating and deploying smart contracts onto a blockchain. Each smart contract described herein may be a set of code that is deployed at a particular address on the blockchain, that, when executed, causes action(s) defined in the smart contract to be automatically initiated when certain triggering event(s) defined in the smart contract occur.

The action(s) defined in a smart contract may relate to maintaining, classifying, and/or restricting access to data relating to vehicle seats stored on a blockchain. For example, a data maintenance smart contract may include a triggering event of detecting one or more sets of data for storage in a data repository. In response to this triggering event, one or more nodes enforcing the data maintenance smart contract may determine whether the one or more sets of data (i) relate to vehicle seats, (ii) classify the data as either publicly accessible or proprietary, and/or (iii) add the data to a data repository. As another example, a security smart contract may include a triggering event of detecting a request to access the one or more sets of data stored on the data repository. In response to this triggering event, one or more nodes enforcing the security smart contract may determine whether the requestor has access to the requested data.

In some embodiments, a blockchain node, such as a server, may generate a particular smart contract to subscribe to one or more feeds of transaction data related to the particular smart contract. Accordingly, the node may route the data included in the subscribed data feeds to the particular smart contract to execute the code of the particular smart contract that determines which, if any, triggering events have occurred. If a triggering event has occurred, the node may execute the corresponding code included in the smart contract that is associated with the occurrence of the triggering event. By executing the code included in the smart contract, it may be said that the node performs one or more actions at the direction of the smart contract. In some embodiments, routing the transactions may include extracting identity data from the transactions and utilizing the identity data to identify one or more smart contracts related to the extracted identity data. The smart contract that matches the identity data may be considered to be the “particular smart contract.” According to some embodiments, the nodes may execute an application to monitor, collect, analyze, and/or otherwise process data that is relevant to the enforcement of a smart contract.

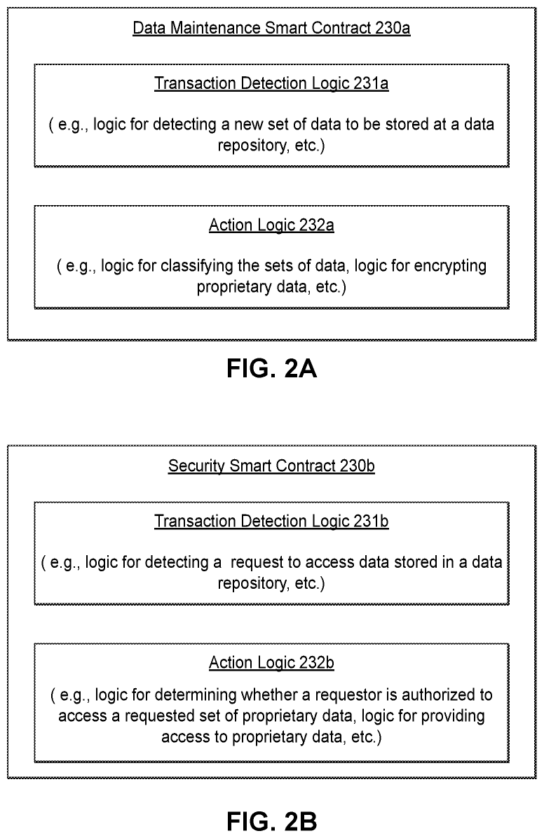

FIG. 2A depicts an exemplary data maintenance smart contract 230a. As shown in FIG. 2A, the data maintenance smart contract 230a may include transaction detection logic 231a, and/or action logic 232a.

The transaction detection logic 231a may include an analysis function that receives, as an input, data associated with one or more transactions written to the blockchain 145. The input data may be included in the transaction itself or stored a location referenced by the transaction. The analysis function may analyze the input data using if-then conditional logic defined by the data maintenance smart contract 230a to set a flag associated with the input data. For example, the analysis function may include logic configured to detect whether the input data is related to vehicle seats and/or whether the input data is publicly available or proprietary.

The action logic 232a specifies a particular action to be performed by the node enforcing the smart contract based upon the flags set by the analysis function performed with respect to the transaction detection logic 231a. For example, if the analysis function sets a flag indicating that the submitted data is related to vehicle seats, then the action data 233a may be logic that, when executed by a node, stores the submitted data to the data repository 160. As another example, if the analysis function sets a flag indicating that the submitted data is proprietary, then the action data 233a may be code that, when executed by a node, encrypts the submitted data.

FIG. 2B depicts an exemplary security smart contract 230b. As shown in FIG. 2B, the security smart contract 230b may include transaction detection logic 231b, and/or action logic 232b.

The transaction detection logic 231b may include an analysis function that receives, as an input, data associated with one or more transactions written to the blockchain 145. The input data may be included in the transaction itself or stored a location referenced by the transaction. The analysis function may analyze the input data using if-then conditional logic defined by the security smart contract 230b to set a flag associated with the input data. For example, the analysis function may include logic configured to detect whether the input data is a request of access to data stored on the data repository 160.

The action logic 232b specifies a particular action to be performed by the node enforcing the smart contract based upon the flags set by the analysis function performed with respect to the transaction detection logic 231b. For example, if the analysis function of the data maintenance smart contract had set a flag indicating that the requested data is proprietary, then the action logic 232b may be logic that, when executed by a node, may use a private key included with the request to attempt to decrypt the public key associated with the requested data.

### Exemplary Signal Diagram

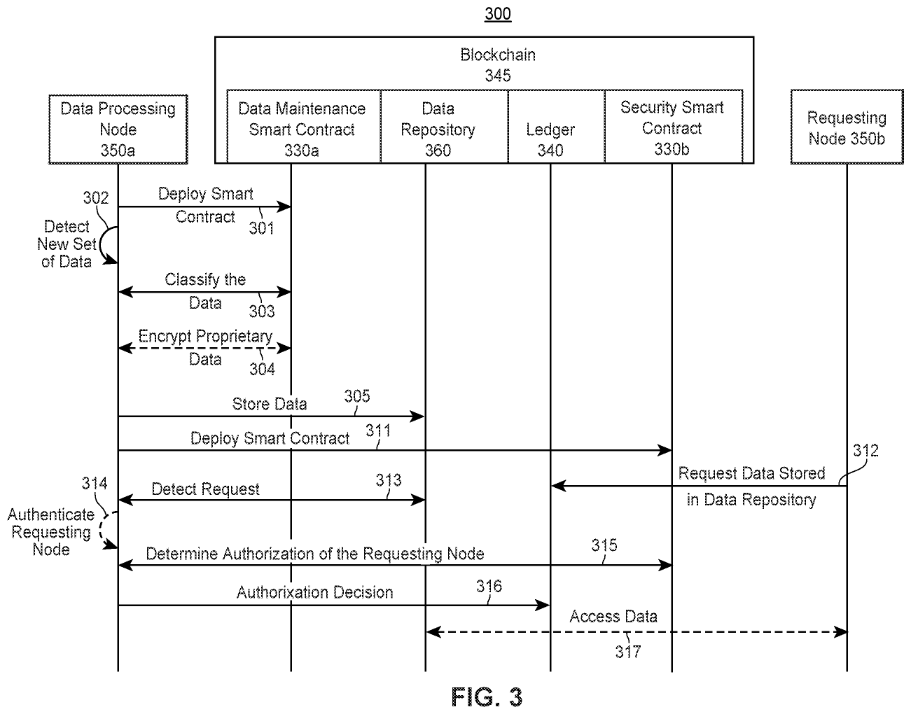

FIG. 3 depicts an exemplary signal diagram 300 for implementing the methods and systems for maintaining and classifying vehicle seat data stored on a blockchain 345 (e.g., blockchain 145 of FIG. 1A). As illustrated, the signal diagram 300 includes a data processing node 350a and a requesting node 350b (either of which may be the node 102, the electronic device 104, and/or nodes and/or electronic devices associated with the one or more entities 150, as described with respect to FIG. 1A) and/or a blockchain 345 (e.g., the blockchain 145 of FIG. 1A). The blockchain 345 may include a data maintenance smart contract 330a, a security smart contract 330b, a ledger 340 of blockchain transactions, and/or a data repository 360 (e.g., the data repository 160 of FIG. 1A).

As illustrated, the signal diagram 300 may begin when the data processing node 350a deploys (301) the data maintenance smart contract 330a to the blockchain 345 to detect, maintain, and/or classify submitted data related to vehicle seats.

The data processing node 350a may then detect (302) one or more sets of data that have been requested to be stored on the data repository 360 of the blockchain 345. For example, the request may be written to the ledger 340 and include the data and/or a reference to where the data may be obtained.

The data processing node 350a may then execute the data maintenance smart contract 330a to classify (303) the data. As an example, the data processing node 350a may analyze the data to determine whether the submitted data is related to vehicle seats. For example, the data processing node 350a may perform a textual analysis the data (including any associated meta data) for specific key words (e.g., “vehicle seat,” “child seat,” “car seat,” “replacement vehicle seat,” etc.). As another example, the processing node 350a may analyze an identity of the node associated with the new data set to determine whether the node is associated with an entity associated with vehicle seats (e.g., whether the node is a vehicle or vehicle seat OEM). If the data processing node 350a determines that the data does not relate to vehicle seats, the data processing node 350a may reject the request to store of the data to the data repository 360.

It should be noted that the term “vehicle seats,” as it is generally used herein, may refer to any vehicle seat that are placed into a vehicle to accommodate and/or otherwise protect toddlers and other small children. Accordingly, the term “vehicle seats” may refer to “toddler seats,” “child seats,” “safety seats,” “booster seats,” etc. In one embodiment, the vehicle seat may be a toddler's seat (e.g., a rear-facing, toddler's vehicle seat) designed to safely accommodate toddlers under a specific age, height, and/or weight (e.g., vehicle seats for toddlers aged two and under). In another embodiment, the vehicle seat may be a child seat (e.g., a forward-facing, children's vehicle seat) designed to safely accommodate children between specific age, height, and/or weight ranges (e.g., vehicle seats for children between 50 lbs. and 100 lbs.). In yet another embodiment, the vehicle seat may be a safety seat (e.g., an adult's booster seat) to safely accommodate individuals at any age but between specific height, and/or weight ranges (e.g., vehicle seats for adults between 3 ft. tall and 5 ft. tall).

Additionally, the data processing node 350a may execute the data maintenance smart contract 330a to classify the data as either “publicly accessible” or “proprietary.” In some embodiments, the data processing node 350a may classify the data based upon an indication included with the request that the data is either “publicly accessible” or “proprietary” (e.g., a signal flag, etc.). Additionally or alternatively, in some embodiments, the data processing node 350a may classify the data as “publicly accessible” based upon whether the data processing node 350a can locate the submitted data on a publicly accessible website and/or other location specified in the data maintenance smart contract 330a. Additionally or alternatively, in some embodiments, the data processing node 350a may classify the submitted data as “publicly accessible” based on an analysis of the node associated with the new set of data. For example, an OEM of a vehicle seat may request proprietary data associated with their vehicle seat models is stored in the repository 360; whereas a government entity may request that their data be publicly available.

If the data processing node 350a classifies the data as “proprietary,” the data processing node 350a may encrypt (304) the data. In some embodiments, the data processing node 350a may encrypt the submitted data by generating a public/private key pair and encrypting the data using the public key. In other embodiments, the data processing node 350a may query a public key database to encrypt the proprietary data using a specific public key previously associated with the new set of data and/or the node associated therewith. As a result, only nodes with the corresponding private key may be able to decrypt the proprietary data.

The data processing node 350a may store (305) the data at the data repository 360, as directed by the data maintenance smart contract 330a. For example, the data maintenance smart contract 330a may include logic that causes the data processing node 350a to generate a new address in the blockchain at which the new set of data can be accessed and store the data at the corresponding address.

Additionally, the processing node 350a may generate and deploy (311) the security smart contract 330b to govern access to the stored set of data. In one embodiment, the logic for generating the security smart contract 330b is included as an action item of the data maintenance smart contract 330a.

Subsequently, the requesting node 350b may write a request (312) transaction to the ledger 340 of the blockchain 345 for access to one or more sets of proprietary data stored at the data repository 360. The request may be configured to include an indication of the requested data. In some embodiments, the request may include a blockchain identifier and/or other identification data associated with the requesting node 350b used to validate the authenticity of the request. For example, the request may include a digital signature generated using the private key associated with the requesting node 350b. Additionally or alternatively, the request may also include identification data (e.g., a PIN number, a serial number or some other identifier of the requesting node 350b, a username or number of an account associated with the requesting node 350b, etc.).

The data processing node 350a may detect (313) the request upon being written to the blockchain 345. In response, the data processing node 350a may execute the security smart contract 330b corresponding to the requested data to verify that the request is proper.

For example, in some embodiments, the data processing node 350a may execute the security smart contract 330b to authenticate (314) the requesting node 350b. In some embodiments, the data processing node 350a may authenticate the requesting node 350b by validating an access credential included with the request. For example, the request may validate a digital signature applied to the request using a public key associated with the requesting node 350b.

If the data processing node 350a authenticates the requesting node, the data processing node 350a may then execute the security smart contract 330b to determine whether the requesting node (or, alternatively, a node the requesting node is requesting access the requested data) is authorized to access the requested data. If the requested data is “publicly available,” the data processing node 350a may authorize all requests. On the other hand, if the requested data is “proprietary,” the data processing node 350a may utilize identification data to compare the comparing the identification data to a list of authorized nodes. In some embodiments, the list is included in the security smart contract 330b associated with the requested data. In this example, determination that the identification data is included in the list of authorized nodes may cause the data processing node 350a to authorize the requesting node 350b to access the requested data.

Upon authentication and/or authorization of the requesting node 350b, the data processing node 350a may write a determination (315) transaction to the ledger 340 of the blockchain 345. If the requesting node 350b has been authorized, the transaction may include a credential for accessing the requested data at the location indicated by the data repository 360. In some embodiments, the credential is encrypted using the public key associated with the requesting node.

The requesting node 350b may then access (317) the requested data. In some embodiments, the requesting node 350b may query the data repository 360 to identify a location associated with the requested data and provide the received credential when generating an access request with the host location. In other embodiments, the data repository 360 may include the raw encrypted data. In these embodiments, the requesting node 350b the credential may be a decryption key used to decrypt the stored data.

Although FIG. 3 depicts only certain embodiments of the interactions between the data processing node 350a, the requesting node 350b, the data maintenance smart contract 330a, and the security smart contract 330b, more or less nodes and/or smart contracts and methods and/or steps of interaction between them are contemplated. This disclosure is not limited to the depiction of FIG. 3, or the description above.

### Exemplary Method

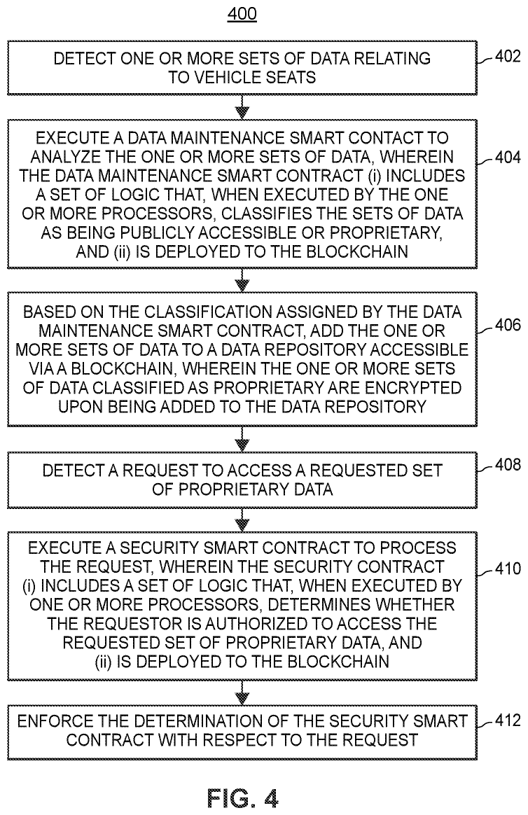

FIG. 4 depicts an exemplary computer-implemented method 400 for generating one or more smart contracts for deployment onto a blockchain. The method 400 may employ any of the techniques, methods, and systems described herein with respect to FIGS. 1A-3.

The method 400 may begin at block 402 when a node (e.g., the node 102) detects, by one or more processors (e.g., the one or more processors 111a), one or more sets of data relating to vehicle seats.

In some embodiments, the one or more sets of data may be obtained from a user device (e.g., the electronic device 104) via one or more communication networks (e.g., the one or more networks 110). Additionally or alternatively, in some embodiments, the node may be a server computing device. In some embodiments, the server computing device may be associated with an insurer of vehicles and/or property, a personal electronic device (e.g., the electronic device 104), one or more entities (e.g., the one or more entities 150) and/or other types of computing devices.

At block 404, the node may execute, by the one or more processors, a data maintenance smart contact to analyze the one or more sets of data, wherein the data maintenance smart contract (i) may include a set of logic that, when executed by the one or more processors, classifies the sets of data as being publicly accessible or proprietary, and (ii) may be deployed to the blockchain.

In some embodiments, the node may execute the data maintenance smart contract may labelling data as either “related” or “not related” to vehicle seats. Then, the node executing the data maintenance smart contract may classify the data labelled as related to vehicle seats as either “publicly accessible” or “proprietary.” In some embodiments, the classification is based upon whether the submitted data contains an indication that the data can be publicly accessed.

Additionally or alternatively, in some embodiments, the classification may also be made based upon the node determining that the data can be located on a publicly accessible website. Additionally or alternatively, the classification of “publicly accessible” may be based upon identification information of an entity associated with the data.

At block 406, the node may add, by the one or more processors, the one or more sets of data to a data repository accessible via a blockchain based upon the classification assigned by the data maintenance smart contract. The one or more sets of data that are classified as proprietary may be encrypted upon being added to the data repository.

In some embodiments, the node may generate a public/private key pair to utilize for interactions with the proprietary data. When attempting to access the proprietary data, a smart contract on the blockchain may request the public key from the node for storage in a public key repository associated with the blockchain.

At block 408, the node may detect, by the one or more processors from a requestor, a request to access a requested set of proprietary data.

In some embodiments, the request may be a transaction written to the blockchain. Additionally or alternatively, in some embodiments, the request may include (i) a digital signature generator based upon a private key of the requestor and/or (ii) identification data of the requestor.

At block 410, the node may execute, by the one or more processors, a security smart contract to process the request, wherein the security contract (i) includes a set of logic that, when executed by the one or more processors, determines whether the requestor is authorized to access the requested set of proprietary data, and (ii) is deployed to the blockchain.

At block 412, the node may enforce, by the one or more processors, the determination of the security smart contract with respect to the request.

In the embodiments where the request includes a digital signature, the node may enforce the security smart contract by determining whether the public key of the requestor decrypts the digital signature. If the private key decrypts the digital signature, the node may authenticate the requestor. On the other hand, if the private key does not decrypt the digital signature, the node may deny the request proprietary data. Additionally, in some embodiments where the request includes identification data of the requestor, the node may enforce the security smart contract by comparing the identification data to a list of users authorized to access the requested proprietary data. If the requestor is included in the list of users, the node may authorize the requestor as having access to the requested proprietary data. On the other hand, if the requestor is not included in the list of users, the node may deny access to the request proprietary data.

The method 400 is not limited to the above-described embodiments. For example, alternative ordering of steps of the method 400 are contemplated. Additionally, the method 400 may include additional, less, and/or alternative steps from any of the methods, systems, and/or techniques described herein.

### Additional Exemplary Embodiments

In one aspect, a computer-implemented method for generating one or more smart contracts for deployment onto a blockchain may be provided. The method may be implemented via one or more local and/or remote processors, transceivers, sensors, servers, memory units, mobile devices, wearables, smart glasses, augmented reality glasses, virtual reality headsets, smart devices, smart glasses, augmented reality (AR) glasses, virtual reality (VR) headsets, extended or mixed reality glasses or headsets, voice bots, chat bots, ChatGPT bots, ChatGPT-based bot, and/or other electronic and/or electrical components, which may be in wired or wireless communication with one another. For example, in one instance, the method may include: (1) detecting, by one or more processors, one or more sets of data relating to vehicle seats; (2) executing, by the one or more processors, a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, adding, by the one or more processors, the one or more sets of data to a data repository accessible via a blockchain, wherein the one or more sets of data classified as proprietary may be encrypted upon being added to the data repository; (4) detecting, by the one or more processors from a requestor, a request to access a requested set of proprietary data; (5) executing, by the one or more processors, a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforcing, by the one or more processors, the determination of the security smart contract with respect to the request. The method may include additional, less, or alternate actions, including those discussed elsewhere herein.

Additionally or alternatively to the above-described method, the request may be a transaction written to the blockchain and/or the request may include identification data of the requestor. Additionally or alternatively, in some embodiments, encrypting a set of proprietary data may further include generating a public/private key pair that includes a public key and a private key associated with the set of proprietary data; and/or encrypting the set of proprietary data using the public key associated with the set of proprietary data.

Additionally or alternatively to the above-described method, in some embodiments, enforcing the security smart contract with respect to the request may further include determining, based upon the security smart contract, that the requestor is authorized to access the requested set of proprietary data; and/or based upon the determination, providing, by the one or more processors to the requestor, the private key associated with the requested set of proprietary data. Alternatively, enforcing the security smart contract with respect to the request may further include determining, based upon the security smart contract, that the requestor is not authorized to access the requested set of proprietary data; and/or based upon the determination, providing, by the one or more processors to the requestor, a notification indicating the requestor is not authorized to access the requested set of proprietary data.

Additionally or alternatively to the above-described method, in some embodiments, enforcing the security smart contract with respect to the request may further include comparing, by the one or more processors, the identification data of the requestor to a list of users authorized to access the requested set of data.

Additionally or alternatively to the above-described method, in some embodiments, executing the data maintenance smart contact to classify a set of data may further include analyzing, by the one or more processors, an identifier associated with the set of data; and/or classifying, by the one or more processors, the set of data in accordance with identifier. Additionally or alternatively, executing the data maintenance smart contact to classify a set of data may further include identifying, by the one or more processors, a source of the set of data; and/or classifying, by the one or more processors, the set of data as proprietary based upon the identified source.

In another aspect, a computer system for generating one or more smart contracts for deployment onto a blockchain may be provided. The computer system may be configured to include one or more local and/or remote processors, transceivers, sensors, servers, memory units, mobile devices, wearables, smart glasses, augmented reality glasses, virtual reality headsets, smart devices, smart glasses, augmented reality (AR) glasses, virtual reality (VR) headsets, extended or mixed reality glasses or headsets, voice bots, chat bots, ChatGPT bots, ChatGPT-based bot, and/or other electronic and/or electrical components, which may be in wired or wireless communication with one another. For example, in one instance, the computer system may include one or more processors; and/or a non-transitory program memory coupled to the one or more processors and/or storing executable instructions that, when executed by the one or more processors, cause the computer system to: (1) detect one or more sets of data relating to vehicle seats; (2) execute a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, add the one or more sets of data to a data repository accessible via a blockchain, wherein the one or more sets of data classified as proprietary may be encrypted upon being added to the data repository; (4) detect a request to access a requested set of proprietary data from a requestor; (5) execute a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforce the determination of the security smart contract with respect to the request. The computer system may be configured to include additional, less, or alternate functionality, including that discussed elsewhere herein.

Additionally or alternatively to the above-described system, the request may be a transaction written to the blockchain and/or the request may include identification data of the requestor. Additionally or alternatively, in some embodiments, encrypting a set of proprietary data may further cause the computer system to generate a public/private key pair that includes a public key and a private key associated with the set of proprietary data; and/or encrypt the set of proprietary data using the public key associated with the set of proprietary data.

Additionally or alternatively to the above-described system, in some embodiments, enforcing the security smart contract with respect to the request may further cause the computer system to determine, based upon the security smart contract, that the requestor is authorized to access the requested set of proprietary data; and/or based upon the determination, provide the private key associated with the requested set of proprietary data to the requestor. Alternatively, enforcing the security smart contract with respect to the request may further cause the computer system to determine, based upon the security smart contract, that the requestor is not authorized to access the requested set of proprietary data; and/or based upon the determination, provide a notification indicating the requestor is not authorized to access the requested set of proprietary data to the requestor.

Additionally or alternatively to the above-described system, in some embodiments, enforcing the security smart contract with respect to the request may further cause the computer system to compare the identification data of the requestor to a list of users authorized to access the requested set of data.

Additionally or alternatively to the above-described system, in some embodiments, executing the data maintenance smart contact to classify a set of data may further cause the computer system to analyze an identifier associated with the set of data; and/or classify the set of data in accordance with identifier. Additionally or alternatively, executing the data maintenance smart contact to classify a set of data may further cause the computer system to identify a source of the set of data; and/or classify the set of data as proprietary based upon the identified source.

In another aspect, a tangible, a non-transitory computer-readable medium may store executable instructions for generating one or more smart contracts for deployment onto a blockchain may be provided. The executable instructions, when executed, may cause one or more processors to: (1) detect one or more sets of data relating to vehicle seats; (2) execute a data maintenance smart contact to analyze the one or more sets of data, wherein the data maintenance smart contract (i) may include a set of logic that, when executed by the one or more processors, may classify the sets of data as being publicly accessible or proprietary, and (ii) may be deployed to the blockchain; (3) based upon the classification assigned by the data maintenance smart contract, add the one or more sets of data to a data repository accessible via a blockchain, wherein the one or more sets of data classified as proprietary may be encrypted upon being added to the data repository; (4) detect a request to access a requested set of proprietary data from a requestor; (5) execute a security smart contract to process the request, wherein the security contract (i) may include a set of logic that, when executed by the one or more processors, may determine whether the requestor is authorized to access the requested set of proprietary data, and (ii) may be deployed to the blockchain; and/or (6) enforce the determination of the security smart contract with respect to the request. The executable instructions may direct additional, less, or alternate functionality, including that discussed elsewhere herein.

Additionally or alternatively to the above-described executable instructions, the request may be a transaction written to the blockchain and/or the request may include identification data of the requestor. Additionally or alternatively, in some embodiments, encrypting a set of proprietary data may further cause the computer system to generate a public/private key pair that includes a public key and a private key associated with the set of proprietary data; and/or encrypt the set of proprietary data using the public key associated with the set of proprietary data.

Additionally or alternatively to the above-described executable instructions, in some embodiments, enforcing the security smart contract with respect to the request may further cause the computer system to determine, based upon the security smart contract, that the requestor is authorized to access the requested set of proprietary data; and/or based upon the determination, provide the private key associated with the requested set of proprietary data to the requestor. Alternatively, enforcing the security smart contract with respect to the request may further cause the computer system to determine, based upon the security smart contract, that the requestor is not authorized to access the requested set of proprietary data; and/or based upon the determination, provide a notification indicating the requestor is not authorized to access the requested set of proprietary data to the requestor.

Additionally or alternatively to the above-described executable instructions, in some embodiments, enforcing the security smart contract with respect to the request may further cause the computer system to compare the identification data of the requestor to a list of users authorized to access the requested set of data.

Additionally or alternatively to the above-described executable instructions, in some embodiments, executing the data maintenance smart contact to classify a set of data may further cause the computer system to analyze an identifier associated with the set of data; and/or classify the set of data in accordance with identifier. Additionally or alternatively, executing the data maintenance smart contact to classify a set of data may further cause the computer system to identify a source of the set of data; and/or classify the set of data as proprietary based upon the identified source.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, some embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules may provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “receiving,” “analyzing,” “generating,” “creating,” “storing,” “deploying,” “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other.

As used herein any reference to “some embodiments” means that a particular element, feature, structure, or characteristic described in connection with the embodiment may be included in at least one embodiment. The appearances of the phrase “some embodiments” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the above-described detailed description be regarded as illustrative rather than limiting, and that it be understood that it is the following claims, including all equivalents, that are intended to define the spirit and scope of this invention.

What is claimed:

1. A computer-implemented method for generating one or more smart contracts for deployment onto a blockchain comprising:
detecting, by one or more processors, one or more sets of data relating to vehicle seats;
executing, by the one or more processors, a data maintenance smart contact to analyze the one or more sets of data, wherein the data maintenance smart contract (i) includes a set of logic that, when executed by the one or more processors, classifies the sets of data as being publicly accessible or proprietary, and (ii) is deployed to the blockchain;
based upon the classification assigned by the data maintenance smart contract, adding, by the one or more processors, the one or more sets of data to a data repository accessible via a blockchain, wherein the one or more sets of data classified as proprietary are encrypted upon being added to the data repository;
detecting, by the one or more processors from a requestor, a request to access a requested set of proprietary data;
executing, by the one or more processors, a security smart contract to process the request, wherein the security contract (i) includes a set of logic that, when executed by the one or more processors, determines whether the requestor is authorized to access the requested set of proprietary data, and (ii) is deployed to the blockchain; and
enforcing, by the one or more processors, the determination of the security smart contract with respect to the request.

2. The computer-implemented method of claim 1, wherein the request is a transaction written to the blockchain.

3. The computer-implemented method of claim 3, wherein encrypting a set of proprietary data comprises:
generating a public/private key pair that includes a public key and a private key associated with the set of proprietary data; and
encrypting the set of proprietary data using the public key associated with the set of proprietary data.

4. The computer-implemented method of claim 3, wherein enforcing the security smart contract with respect to the request comprises:
determining, based upon the security smart contract, that the requestor is authorized to access the requested set of proprietary data; and
based upon the determination, providing, by the one or more processors to the requestor, the private key associated with the requested set of proprietary data.

5. The computer-implemented method of claim 3, wherein enforcing the security smart contract with respect to the request comprises:
determining, based upon the security smart contract, that the requestor is not authorized to access the requested set of proprietary data; and
based upon the determination, providing, by the one or more processors to the requestor, a notification indicating the requestor is not authorized to access the requested set of proprietary data.

6. The computer-implemented method of claim 2, wherein the request includes identification data of the requestor.

7. The computer-implemented method of claim 5, wherein enforcing the security smart contract with respect to the request comprises:
comparing, by the one or more processors, the identification data of the requestor to a list of users authorized to access the requested set of data.

8. The computer-implemented method of claim 1, wherein executing the data maintenance smart contact to classify a set of data comprises:
analyzing, by the one or more processors, an identifier associated with the set of data; and
classifying, by the one or more processors, the set of data in accordance with identifier.

9. The computer-implemented method of claim 1, wherein executing the data maintenance smart contact to classify a set of data comprises:
identifying, by the one or more processors, a source of the set of data; and
classifying, by the one or more processors, the set of data as proprietary based upon the identified source.

10. A computer system for generating one or more smart contracts for deployment onto a blockchain comprising:
one or more processors;
a non-transitory program memory coupled to the one or more processors and storing executable instructions that, when executed by the one or more processors, cause the computer system to:
detect one or more sets of data relating to vehicle seats;
execute a data maintenance smart contact to analyze the one or more sets of data, wherein the data maintenance smart contract (i) includes a set of logic that, when executed by the one or more processors, classifies the sets of data as being publicly accessible or proprietary, and (ii) is deployed to the blockchain;
based upon the classification assigned by the data maintenance smart contract, add the one or more sets of data to a data repository accessible via a blockchain, wherein the one or more sets of data classified as proprietary are encrypted upon being added to the data repository;
detect a request to access a requested set of proprietary data from a requestor;
execute a security smart contract to process the request, wherein the security contract (i) includes a set of logic that, when executed by the one or more processors, determines whether the requestor is authorized to access the requested set of proprietary data, and (ii) is deployed to the blockchain; and
enforce the determination of the security smart contract with respect to the request.

11. The computer system of claim 10, wherein the request is a transaction written to the blockchain.

12. The computer system of claim 11, wherein encrypting a set of proprietary data causes the computer system to:
generate a public/private key pair that includes a public key and a private key associated with the set of proprietary data; and
encrypt the set of proprietary data using the public key associated with the set of proprietary data.

13. The computer system of claim 12, wherein enforcing the security smart contract with respect to the request causes the computer system to:
determine, based upon the security smart contract, that the requestor is authorized to access the requested set of proprietary data; and
based upon the determination, provide the private key associated with the requested set of proprietary data to the requestor.

14. The computer system of claim 12, wherein enforcing the security smart contract with respect to the request causes the computer system to:
determine based upon the security smart contract, that the requestor is not authorized to access the requested set of proprietary data; and
based upon the determination, provide a notification indicating the requestor is not authorized to access the requested set of proprietary data to the requestor.

15. The computer system of claim 11, wherein the request includes identification data of the requestor.

16. The computer system of claim 14, wherein enforcing the security smart contract with respect to the request causes the computer system to:
compare the identification data of the requestor to a list of users authorized to access the requested set of data.

17. The computer system of claim 10, wherein executing the data maintenance smart contact to classify a set of data causes the computer system to:
analyze an identifier associated with the set of data; and
classify the set of data in accordance with identifier.

18. The computer system of claim 10, wherein executing the data maintenance smart contact to classify a set of data causes the computer system to:
identify a source of the set of data; and
classify the set of data as proprietary based upon the identified source.

19. A tangible, non-transitory computer-readable medium storing executable instructions for generating one or more smart contracts for deployment onto a blockchain, the instructions, when executed by one or more processors of a computer system, cause the computer system to:
detect one or more sets of data relating to vehicle seats;
execute a data maintenance smart contact to analyze the one or more sets of data, wherein the data maintenance smart contract (i) includes a set of logic that, when executed by the one or more processors, classifies the sets of data as being publicly accessible or proprietary, and (ii) is deployed to the blockchain;
based upon the classification assigned by the data maintenance smart contract, add the one or more sets of data to a data repository accessible via a blockchain, wherein the one or more sets of data classified as proprietary are encrypted upon being added to the data repository;
detect a request to access a requested set of proprietary data from a requestor;
execute a security smart contract to process the request, wherein the security contract (i) includes a set of logic that, when executed by the one or more processors, determines whether the requestor is authorized to access the requested set of proprietary data, and (ii) is deployed to the blockchain; and
enforce the determination of the security smart contract with respect to the request.
